(19) United States
(12) Patent Application Publication
(10) Pub. No.: US 2008/0201873 A1
(43) Pub. Date: Aug. 28, 2008

(54) Vehicle ramp

(76) Inventor: Efraim Haimoff, Mevasseret Zion (IL)

Correspondence Address: EMPK & Shiloh, LLP, 116 JOHN ST,, SUITE 1201, NEW YORK, NY, 10038, US

(21) Appl. No.: 12/071,301

(22) Filed: Feb. 20, 2008

Related U.S. Application Data
(60) Provisional application No. 60/902,507, filed on Feb. 22, 2007.

(51) Int. Cl. B66F 7/24; E01D 1/00

(52) U.S. Cl. 14/69.5

(57) ABSTRACT

There is provided herein a stackable vehicle ramp comprising: an exterior structure comprising a top formed with an inclined surface, a substantially horizontal resting surface, side surfaces and a rear surface; the resting portion further comprising an upwardly extending rigid member, adjacent to the rear portion and extending transversely across a portion of the width of the resting portion; a support plane comprised of a lowermost portion of the side and rear surfaces and adapted to lie against a medium surface; wherein, the stackable vehicle ramp further comprises at least one hollow and tapered support member extending downwardly from at least the resting portion and the inclined top surface to the support plane, and the side surfaces and the rear surface are substantially beveled such that the ramp is nestably stackable within a second vehicle ramp of a same construction.

### CROSS-REFERENCED APPLICATIONS

This application claims the benefit of U.S. provisional application No. 60/902,507, filed Feb. 22, 2007, which is hereby incorporated by reference in its entirety.

### FIELD OF THE INVENTION

The present invention relates to portable vehicle ramps that are driven upon to elevate a vehicle and allow access to the underside thereof.

### BACKGROUND OF THE INVENTION

Many vehicle owners perform checkups, routine maintenance and repairs on their vehicles. In order to gain easy access to the underside of the vehicles, they will elevate either the front or- rear portion on which they are working to provide such access. Various portable ramps have been used by amateur auto mechanics and vehicle owners for this purpose. These ramps are usually formed of metal and have various configurations to enable the vehicle wheel to be driven up to the inclined portion of the ramp, after which it settles into a wheel retaining area of the ramp. Such wheel retaining areas can be concave or substantially horizontal. Prior examples of such metal ramps are shown in U.S. Pat. Nos. 4,050403, 5,324,004 and AU2004100715.

Several types of non-metal car ramps are also known in the art. For example, U.S. Pat. No. 5,483,715 describes a vehicle service ramp comprising a unitary ramp having an external structure including a rear wall, a pair of side walls and a front. The front includes a surface sloping upward to a top flat plane. The ramp has an internal structure forming a honeycomb pattern of supporting walls extending between the rear wall, side walls and front. The ramp is formed from a foamed polymer. U.S. Re. 34,889 describes a portable vehicle service ramp capable of being used by aerodynamic vehicles and heavy trucks. The ramp is solid on all sides, with integrated handles on the sides and rear. The base and rear of the structure are covered with a corrosive-and-wear resistant material. The incline and top plane area of the ramp are covered with non-skid material, and a wheel stop is provided. The internal construction is a system of cross members running longitudinally and transversely to provide weight bearing capability.

Although many of these prior art ramps may be satisfactory for the intended purpose, it is always desirable to be able to manufacture a lightweight, high strength, portable vehicle ramp with reduced cost in order for it to be more easily handled by the user but without sacrificing any safety to the user thereof

### SUMMARY OF THE INVENTION

It is thus the object of the present invention to provide a lightweight yet sturdy, durable, easily stored and transported vehicle ramp, free of moving parts which require extra manipulation by the user thereof and are subject to breakage and maintenance as an integral one piece member. Therefore, the improved vehicle ramp, according to the present invention, enables the user to drive one of the vehicle wheels along the ramp to a safe resting position.

According to the present invention, there is provided a nestable stackable vehicle ramp, made of molded plastic material and rigidified by one or more integrated reinforcing arrangements, and whereby, at the nestable stackable position, the stack of ramps occupies only a minimal space and remains a steady stack.

The present invention thus provides a vehicle ramp comprising an exterior structure comprising a top surface formed with an inclined surface and a substantially horizontal resting surface, side surfaces extending from said top and a rear surface extending from the top and intermediate rear ends of the side walls; the resting portion further comprising an upwardly extending rigid member adjacent to the rear portion and extending transversely across a portion of the width of the resting portion; and at least one hollow support member extending downwardly from the top surface, said at least one support member and the side surfaces and the rear surface are substantially beveled and taper downwards such that the ramp is nestably stackable within a vehicle ramp of a same construction.

The vehicle, according to the present invention, may be further designed in accordance with any one or more of the following features:
the structure is a made of a high strength plastic molded compound;
an anti-skid member is articulated at a proximal end of the inclined portion;
a bottom most edge of the side walls and the rear wall define a ground-engaging surface on which the ramp rests over the ground;
a rail extends along opposite side edges of the resting portion and/or the inclined portion; said rail being continuous or interrupted;
the inclined portion comprises an aperture adjacent the proximal end;
the rear wall comprises an opening useful as a handle;
a bottom surface of at least the inclined surface and the resting surface comprises an array of reinforcing ribs;
said reinforcing ribs, adjacent the sides are formed with an indentation corresponding with the rail on the top surface, for at least partially accommodating the side rail of-a nested rack to thereby minimize the height off stack of ramps;
the side walls are formed with reinforcing elements for load bearing and improved surface contact;
the at least one support member extending from the top surface extends to the ground engaging surface and is substantially vertical with respect thereto; said at least one support member may be apertured at its bottom for drainage of liquids therefrom; optionally, a bottom of the at least one support member is formed with or comprises an anti-skid member;
at least a portion of the top surface is integrally formed with or applied with an anti-skid surface.

While the present invention will be fully described hereinafter with reference to the accompanying drawings, in which particular embodiments are shown, it is to be understood at the outset that persons skilled in the art may modify the embodiments disclosed herein while still achieving the desired results. Accordingly, the description that follows is to be understood as a broad informative disclosure directed to persons skilled in the appropriate art and not as limitations of the present disclosure.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIG. 1 is a front perspective view of the ramp in accordance with an embodiment of the present invention;

FIG. 2 is a rear perspective view of the ramp illustrated in FIG. 1; with a modification of the top surface thereof;

FIG. 3 is a bottom perspective view of a ramp according to an embodiment of the present invention;

FIG. 4. is a top view of the ramp of fig, 1;

FIG. 5 is a rear perspective view of the ramp, sectioned along line V-V in FIG. 4;

FIG. 6 is a front view of nestably stacked ramps in accordance, with the embodiment-illustrated in FIG. 1;

FIG. 7. is a side view of the ramp-stack of FIG. 6;

FIG. 8 is a longitudinal section of the ramp-stack of FIG. 6;

FIG. 9 is a side view illustrating a multiple-story stack of ramps according to the present invention; and

FIGS. 10 to 13 illustrate variations of ramps according to the present invention; wherein FIGS. 10A, 11A, 12A, and 13A are top isometric views thereof and FIGS. 10B, 11B, 12B, and 13B are bottom isometric views thereof, respectively.

### DETAILED DESCRIPTION OF EXEMPLARY EMBODIMENTS

In the Figures, like reference numerals indicate the same elements throughout.

A ramp, according to one embodiment of the present invention, is illustrated in the accompanying drawings and is generally designated 100.

Ramp 100 can be made of a variety of materials. Ideally, ramp 100 is injection molded from a durable plastic material so as to have a unitary structure. These plastics can be used with a variety of resins and additives to meet particular needs or desires for ramp 100 and the environment in which ramp 100 will be used. For example, the material can be reinforced by introduction of nylon fibers; the surface of the ramp can be, for example, given a roughened, coarse or grained texture. Ramp 100 may also be molded or coated with agents such as UV retardants, protective coating (for example, against corrosive liquids, and so forth).

Ramp 100 according to the present invention is a solid, unitary ramp. Unitary ramp 100 has a proximal portion 110 and a distal portion 112.

Unitary ramp 100 is composed of several walls constituting together an external surface generally designated E. External surface E is composed of a top T which in turn is composed of an inclined portion 102 and a substantially horizontal parking portion 104. Inclined surface 102 serves as an ascending/descending surface and has a proximal end 102a and a distal end 102b. Proximal end 102a blends with proximal portion 110 of ramp 100 and parking portion 104 has a proximal end 104a end integrated with distal end 102b of inclined surface 102 and a distal end 104b integrated with distal portion 112 of the ramp 100 whereby inclined portion 102 and parking portion 104 continuously and uniformly extend.

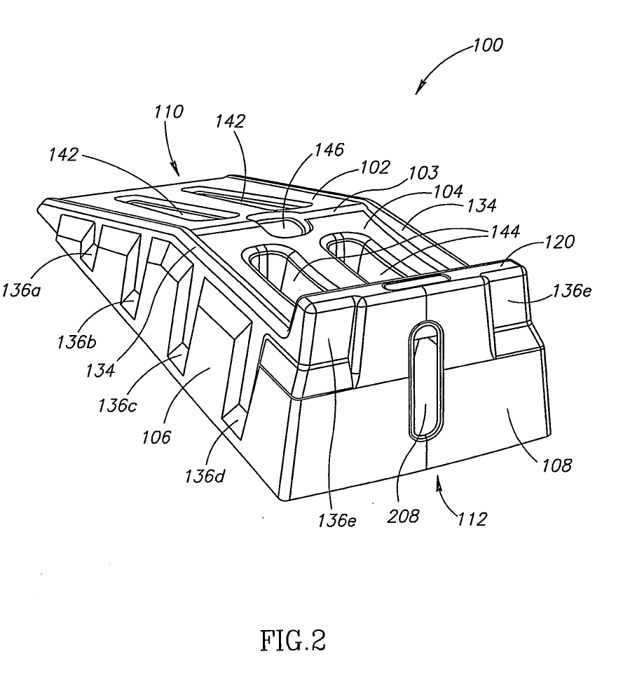

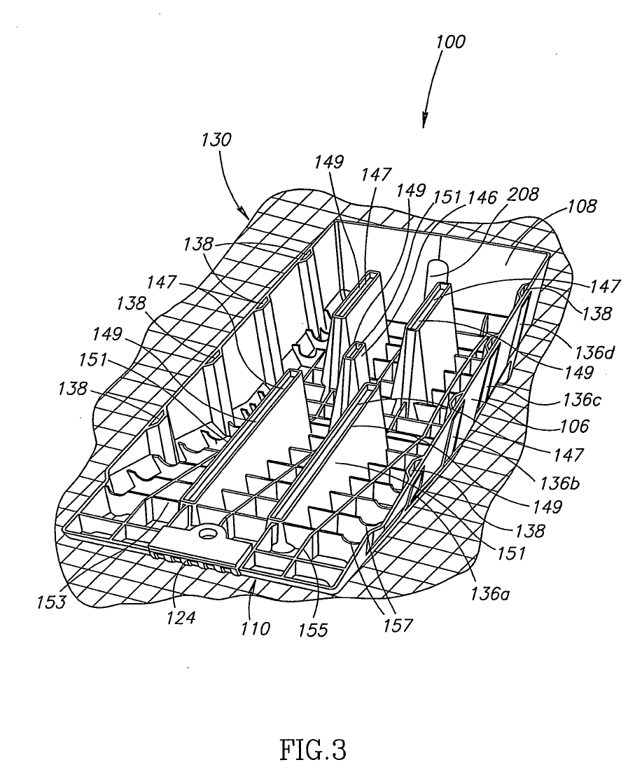

External surface E further comprises continuous side surfaces 106 extending from proximal end 110 to distal end 112, and a rear surface 108 [best seen in FIGS. 2 and 3) connecting two side surfaces 106 and extending downwardly from distal end 112 to a ground surface.

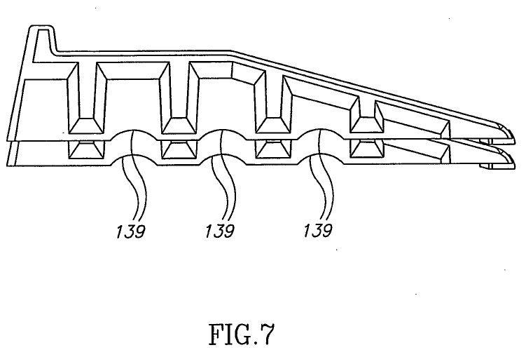

Side walls 106 may have a continuous bottom perimeter for bearing on the ground surface, though according to some embodiments, said side walls may be formed with cutouts 139 (FIG. 7).

Distal end 112 of ramp 100 further comprises a stopping member 120 upwardly extending from the parking portion 104 and transversely extending across the width of parking portion 104.

The lower most portions of side surfaces 106, tear wall 108 and proximal end 110 of ramp 100 define a support plane generally designated 130 which lays against the ground when in use.

The underside of proximal portion 110 of ramp 100 is provided in the illustrated embodiment with an anti skid member 124 (FIG. 3) in the form of a rubber friction pad articulated to the proximal end of ramp 100.

Anti skid member 124 can be formed of a compressible durable material, such as rubber, and be sized to optionally project outwardly along a minor portion of proximal end 102a of inclined portion 102.

In use, anti skid member 124 is pressed firmly against the ground surface under the weight of a vehicle wheel advancing and ascending along inclined portion 102 of ramp 100, adding drag effect between ramp 100 and the ground (not shown), thereby reducing the kickback tendency, such that ramp 100 is less prone to move when driven upon, or descended from.

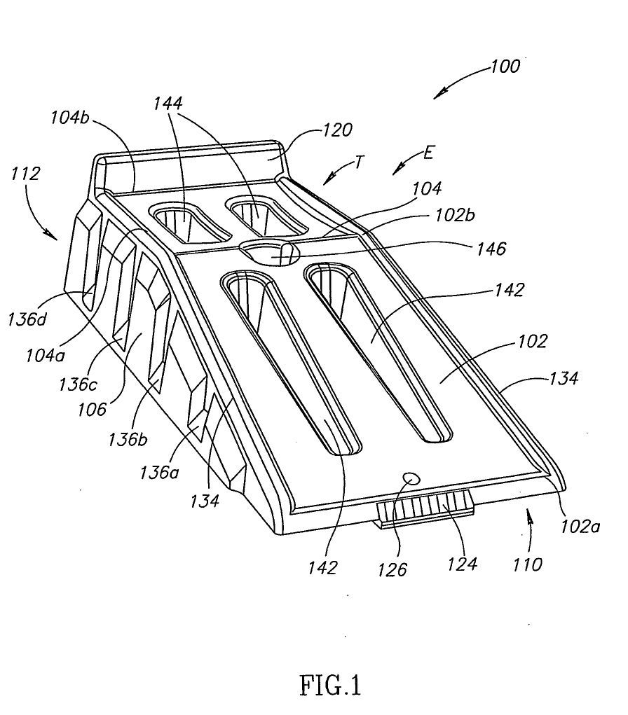

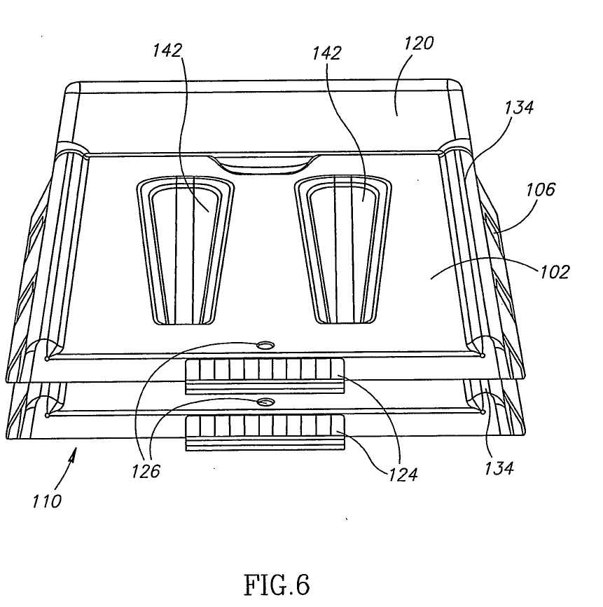

According to a particular embodiment of the invention, adjacent the proximal end 110 of the ramp 100 there is an aperture 126 (seen in FIGS. 1, 3). Aperture 126 is adapted for receiving fasteners, for example, a bolt, therethrough for confining ramp 100, for example to the ground surface. Aperture 126 can also be utilized for hanging ramp 100 or for connecting several ramps 100 of the same construction, for instance, when nestably stacked (as illustrated in FIGS. 6-9) by passing a wire or a rope through the corresponding apertures 126 and tying them together.

Rear wall 108 of ramp 100 has a carrying portion in a form of a centered and cut-out area (FIGS. 2 and 3) designated 208. Cut-out area 208 has rounded edges and can be used as a handle to ease positioning and handling of ramp 100.

A side rail 134 extends along opposite sides of parking portion 104 and inclined portion 102. Rail 134 in this embodiment is continuous, however, according to the present invention, rail 134 can be segmented. Such side rail 134 is useful for guiding the wheel along ramp 100 and preventing running off of the wheel.

Side surfaces 106 are slightly inclined with respect to a vertical so that they taper towards each other over a height of ramp 100. This enables two or more ramps of similar design to be nested together to form a stack generally designated 600 as illustrated in FIGS. 6-9.

The structure of ramp 100 is subjected to forces by the weight of the vehicle as it drives up over inclined portion 102 and further onto the substantial horizontal parking portion 104. Thus, although durable and high strength plastic materials are used, in order to increase load bearing capacity, several support means are introduced.

According to one embodiment, as illustrated, for example, in FIGS. 1 and 2, side surfaces 106 and rear wall 108 comprise a plurality of inwardly extending depressions 136a, 136b, 136c, 136e and 136d, varying in size depending on their location along the side wall or rear wall, respectively, which provide for a better surface contact with the ground (not shown) and, in particular, impart ramp 100 rigidity. It is appreciated that the configuration of depressions 136 is such that at the nested position (FIGS. 6-9) said depressions are nested within each other. For this purpose, it is required that depressions 136 be equally tapering. In the bottom view of FIG. 3 it is seen that depressions 136 are formed at their bottom end with a reinforced double walled portion (a hollow core structure) 138. However, such depressions are not shown in the embodiments of FIGS. 7-10.

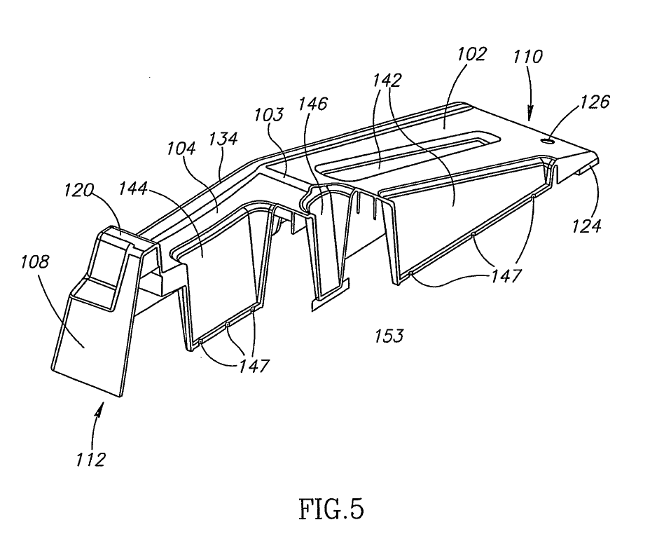

Ramp 100, according to the present invention, further comprises at least one hollow support member extending downwardly from the top T surface towards support plane 130. According to one specific embodiment of the present invention as illustrated in FIGS. 1-3, ramp 100 comprises a total of five support members, namely two integrated support members 144 extending downwardly from the horizontal portion 104 to the support plane, two members 142 extending downwardly from the inclined surface 102, and a central support member 146 extending downwardly towards support plane 130 from the interconnecting zone between horizontal portion 104 and inclined portion 102, Support members 142, 144, 146 are hollow, and tapered such that they are nestable at the nesting position (FIGS. 6-9). This can best be seen, in FIG. 5 of the drawings.

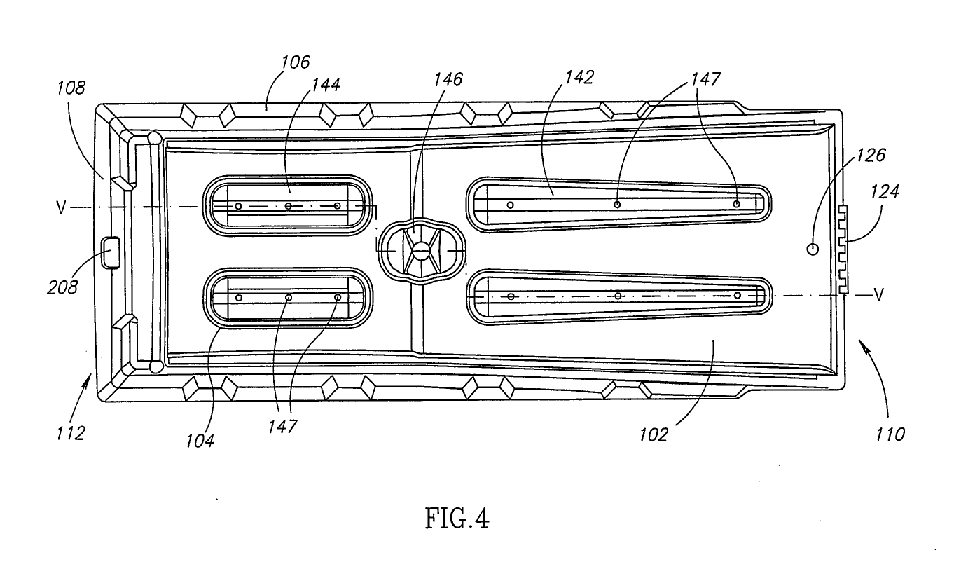

According to the illustrated embodiment in FIGS. 1-5 and 7-10 support members 142, 144, 146 each have a closed bottom end. However, the support members according to the present invention can have an open bottom end. The support members as illustrated in FIGS. 1-3 further comprise draining openings 147 in the close end adapted to prevent water/moisture from accumulating therein.

In an embodiment illustrated in FIG. 3, it can be seen that base 149 of the support members is slightly above a bottom rim 151 of each of the respective support members in order to allow ventilation and drainage. However, according to another embodiment, the rim can be an added rubber sole member to prevent displacement of the support member when a vehicle drives up thereon. According to yet another embodiment, an anti skid member 153 can be further added to the bottom of one or more of the support members, that is, central support member 146 as in FIG. 5.

Also noted in the drawings, substantially horizontal parking portion 104 is slightly concave (best seen in FIGS. 1, 2 and 5) so as to better arrest the vehicle's wheel (not shown) once positioned thereon. Even more so, according to some particular embodiments, between parking portion 104 and inclined portion 102, there is a ridge 103 (FIGS. 2 and 5) to increase the vehicle's arresting over parking portion 104.

The support members of the present invention can be of any shape, size, combination and pattern. According to a specific embodiment of the present invention, the hollow tapered support member extends downwardly from horizontal portion 104 and the inclined portion 102 and are each formed with conical side walls and a top circular/elliptical upper opening on the exterior/top surface of ramp 100. Such hollow and tapered structure of the support members enables two or more ramps of the same structure to be nested to form a stack as illustrated in the drawings.

As can further be noted in FIG. 3, the bottom face of the ramp is formed with an array of warp and weft reinforcing ribs 153 and 155, respectively. These ribs serve to rigidify ramp 100 and render it suitable for bearing the load of a vehicle. The density of the ribs, their thickness and their shape may vary, depending on the load the ramp is intended to bear.

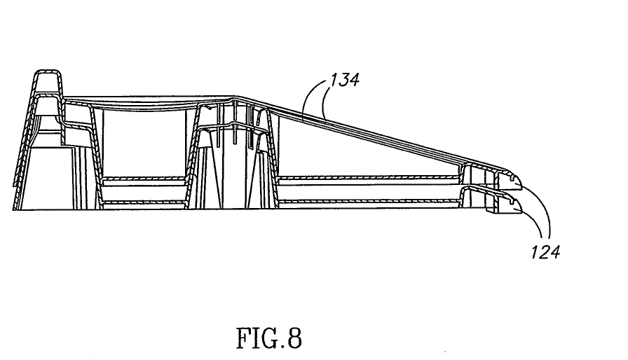

The height of support ribs 153 and 155 is such as to reduce the height of a-stack of ramps. It is further noted that transversally extending ribs 153 are each formed adjacent their respective side ends with a cutout 157, where all said cutouts are aligned so as to correspond with side rail 134 of a ramp 100 nested below, thus reducing the overall height of a stack of ramps, as illustrated, for example, in FIG. 8.

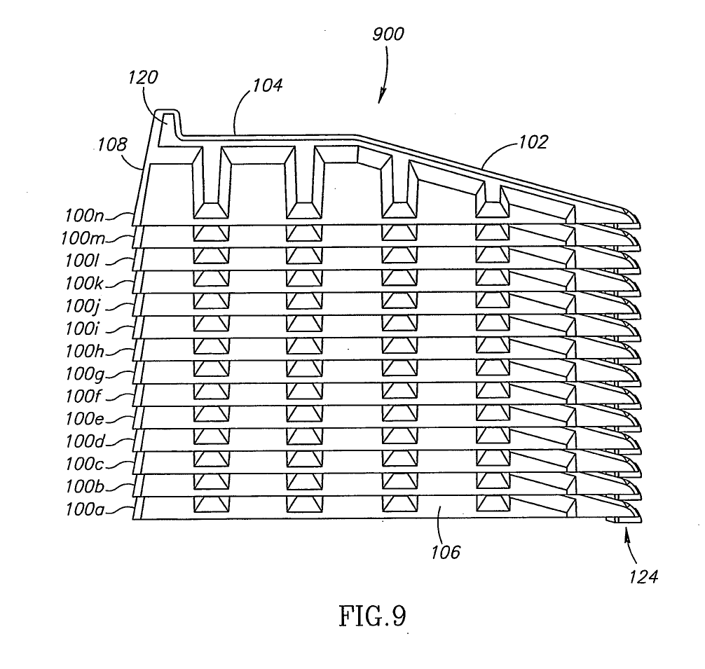

An advantage of the present invention is illustrated in FIG. 9 depicting a stack 900 of fourteen nestingly stacked ramps 100a to 100n of similar construction, in accordance with the present invention. As can be seen, even with such a high number of ramps 100 no skewing/bending effect occurs to any of the ramps 100 or the stack 900 thereof, often caused by presence of gaps between stacked vehicle ramps. It is clearly noticed that stack 900 including top ramp 100n retain parallel relationship to bottom ramp 100a, whilst requiring substantially low storage space and being compact in size and weight.

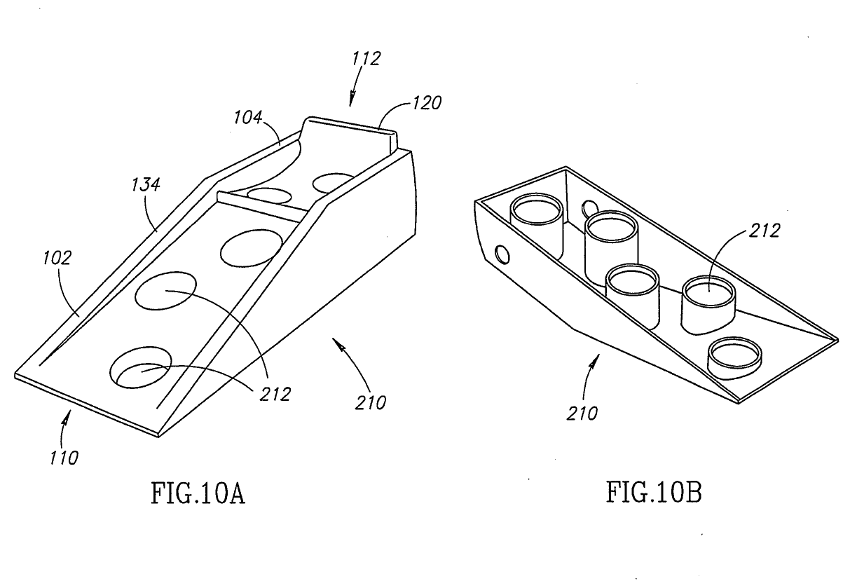

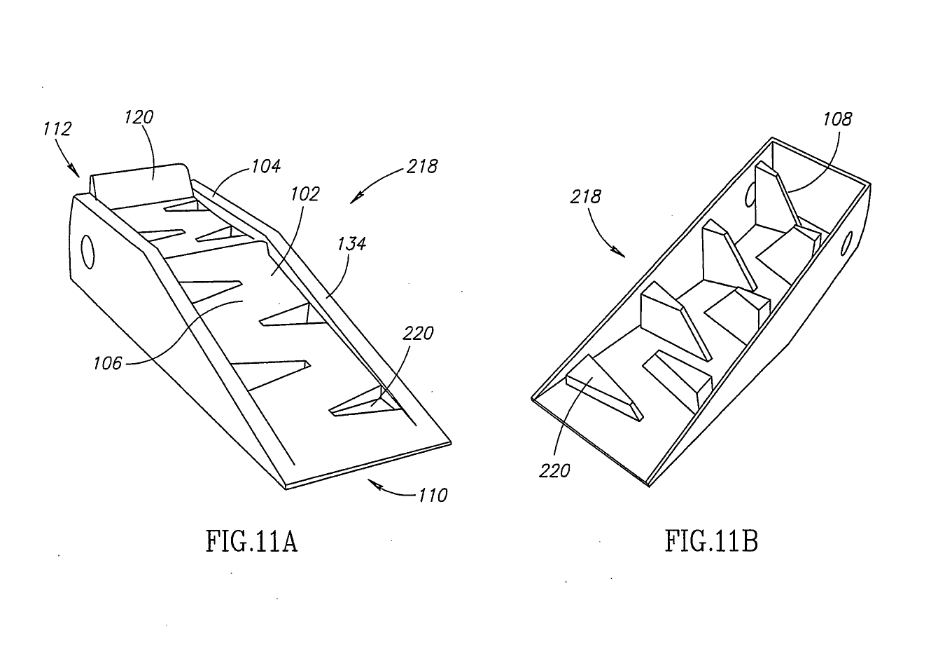

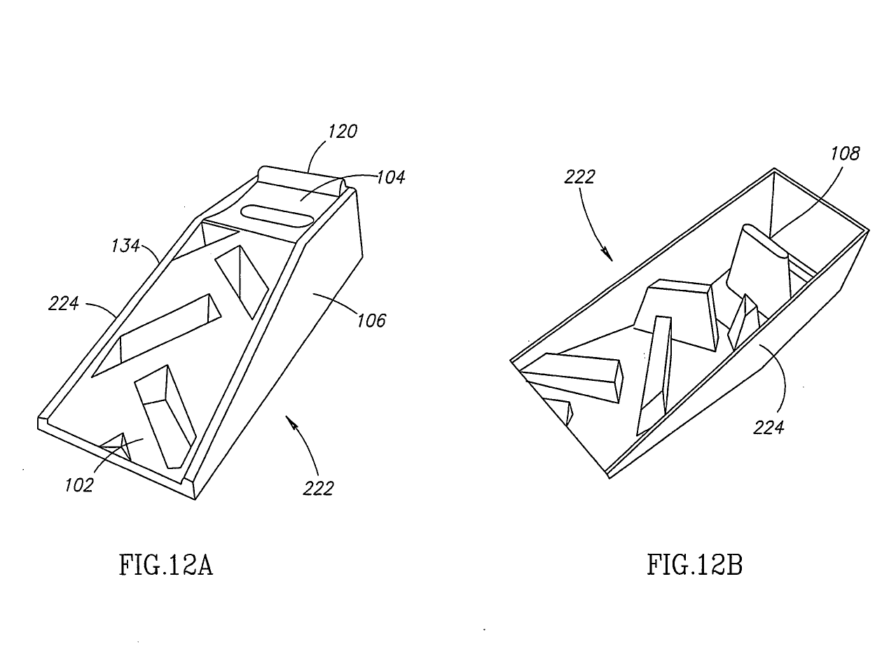

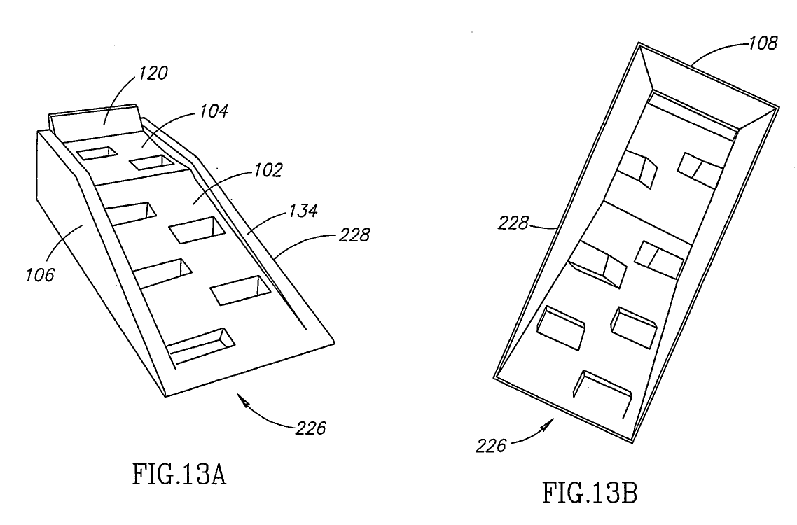

The embodiments of FIGS. 10 to 14 are modifications of the ramp according to the present invention, each having a general shape as disclosed hereinabove, however differing in the shape of the downwardly extending support members. In FIGS. 10A and 10B ramp 210 is formed with cylindrical support elements 212; in the embodiment of FIGS. 11A and 11B ramp 218 is formed with triangular support elements 220; in the embodiment of FIGS. 12A and 12B ramp 222 is formed with rectangle support elements 224 extending at angle with respect to a longitudinal axis of the ramp; and in the embodiment of FIGS. 13A and 13B ramp 226 is formed with rectangle support elements 228 extending substantially parallel to one another, interlacing from opposite sides of ramp 226.

It is, however, noted that all said support members extend from the respective top surface T and extend to the plane defined by the perimeter of the respective ramp, such that when the ramp is positioned on a substantially flat surface, all said support members bear against the ground surface and serve as load bearing elements. Even more so, it is apparent that all said support members are of tapering design so as to facilitate nesting stacking, as discussed hereinabove with reference to the previous drawings, whilst maintaining a minimal height of the stack of ramps, Still, all the support members of the ramps, according to the present invention, have a longitudinal axis extending substantially vertical from the support, plane of the ramp.

Those skilled in the art to which this invention pertains will readily appreciate that numerous changes, variations, and modifications can be made without departing from the scope of the invention, mutatis mutandis.

1. A stackable vehicle ramp comprising:
(a) an exterior structure comprising a top formed with an inclined surface, a substantially horizontal resting surface, side surfaces and a rear surface; the resting portion further comprising an upwardly extending rigid member, adjacent to the rear portion and extending transversely across a portion of the width of the resting portion;
(b) a support plane comprised of a lowermost portion of the side and rear surfaces and adapted to lie against a medium surface;
wherein, the stackable vehicle ramp further comprises at least one hollow and tapered support member extending downwardly from at least the resting portion and the inclined top surface to the support plane, and the side surfaces and the rear surface are substantially beveled such that the ramp is nestably stackable within a second vehicle ramp of a same construction.

2. The ramp of claim 1, wherein the structure is a made of a high strength plastic type compound.

3. The ramp of claim 1, wherein the inclined portion has a tapered edge at a proximal end comprising an anti skid member secured thereto, intended to lie against the medium surface.

4. The ramp of claim 1, wherein a rail extends along opposite sides of the resting portion and the inclined portion.

5. The ramp of claim 4, wherein the rail is continuous.

6. The ramp of claim 4, wherein the rail is segmented.

7. The ramp of claim 3, wherein the inclined portion comprises an aperture at the proximal end.

8. The ramp of claim 1, wherein a bottom surface of at least the inclined surface and the resting surface comprises a honeycomb system of interlocking members disposed thereon.

9. The ramp of claim 1, wherein at least the side surface comprises plurality of at least outwardly and laterally extending bulges for better surface contact and rigidity.

10. The ramp of claim 1, wherein the structure comprises a plurality of substantially tapered support members.

11. The ramp of claim 1, wherein the at least one substantially tapered support member is of a shape chosen from: conical, elliptical, polyhedron and polygonal.

12. The ramp of claim 1, wherein the at least one substantially tapered support member has a closed bottom end.

13. The ramp of claim 1, wherein the at least one substantially tapered support member has at least one opening at a closed bottom end.

14. The ramp of claim 1 wherein the at least one substantially tapered support member has an open bottom end.

15. The ramp of claim 1, wherein the at least one substantially tapered support member has a rubber rim on a bottom surface thereof.

16. The ramp of claim 1, wherein at least the inclined top surface is non-skid.

17. The ramp of claim 1, wherein at least the inclined top surface and at least the resting surface are non skid.

18. The ramp of claim 1, wherein at least the rear surface has a handle in a form of cutout through a wall portion.
